(19) United States
(12) Patent Application Publication
(10) Pub. No.: US 2021/0079261 A1
(43) Pub. Date: Mar. 18, 2021

(54) COATINGS FOR PACKAGING MATERIAL

(71) Applicant: WestRock MWV, LLC, Atlanta, GA (US)

(72) Inventors: Christopher C. Jameson, Richmond, VA (US); William Statelman, Richmond, VA (US); Erin M. Allen, Atlanta, GA (US); Steven G. Bushhouse, Quinton, VA (US); Brian K. Knapp, West Point, VA (US)

(21) Appl. No.: 17/018,506

(22) Filed: Sep. 11, 2020

Related U.S. Application Data
(60) Provisional application No. 62/901,960, filed on Sep. 18, 2019.

(51) Int. Cl. C09D 191/06; B65D 65/42

(52) U.S. Cl. CPC C09D 191/06; C08K 3/26; C08K 2201/005; B65D 65/42

(57) ABSTRACT

A packaging blank can include a paper base, and a coating disposed on and/or within the paper base. The coating can include wax and at least some calcium carbonate. The paper base can be corrugated paper board, for example. The wax can be or include paraffin wax, or any other suitable wax or substance that performs similarly to wax (e.g., for moisture proofing) and can be mixed with calcium carbonate.

### BACKGROUND

### 1. Field

This disclosure relates to packaging, e.g., corrugated paper blanks and packages made therefrom, and coatings (e.g., wax coatings) therefor.

### 2. Background

Certain package materials such as corrugated board (e.g., for produce packages) utilize a wax coating on a paper base material. Traditional cascade wax coating processes utilize waxes such as paraffin that both forms an outer coating and is absorbed into the paper. The wax coatings provide moisture resistance for boxes, trays, bins and other containers made from the coated materials when used to package moist products such as produce, meat, seafood and live plants. In addition, as recognized in the art, the wax uptake into the paper material results in increased strength for the material when compared with an untreated paper substrate. This in turn increases the strength of the containers made from the coated material.

Such conventional methods and systems have generally been considered satisfactory for their intended purpose. However, the wax coating must be sufficiently heavy to achieve the desired results. If too light a coating is applied, the moisture resistance may be ineffective or compromised. Similarly, the desired strengthening may not be realized, in which event the weight of the paper material may have to be increased. On the other hand, the wax material is a relatively expensive component of the finished container, so it is desirable to minimize the amount of wax required.

It has been proposed, for example in U.S. Pat. No. 7,915,183 to incorporate various fillers into the coating to replace a portion of the wax. However, further reduction of wax use remains desirable. There is thus a need in the art for improved coatings in which satisfactory performance can be achieved while reducing wax consumption. The present disclosure provides a solution for this need.

### SUMMARY

A packaging blank can include a paper base, and a coating disposed on and/or within the paper base. The coating can include wax and at least some ground calcium carbonate that is untreated with stearic acid. The paper base can be corrugated paper board, for example. The wax can be or include paraffin wax, or any other suitable wax or substance that performs similarly to wax (e.g., for moisture proofing) and can be mixed with calcium carbonate.

The at least some calcium carbonate can be between greater than zero percent by weight and less than about 50% by weight of the coating. For example, the at least some calcium carbonate can be between about 10% by weight and about 40% by weight of the coating. Any other suitable amount of calcium carbonate for the coating (e.g., to provide increased strength without compromising the function of the wax) is contemplated herein.

The coating can be disposed on at least one exterior surface of the paper base. The coating can be disposed on at least one interior surface of the paper base. The coating can be disposed on all surfaces of the paper base.

In accordance with at least one aspect of this disclosure, a package can be created from at least one packaging blank. The package can include any suitable packaging blanks and/or features thereof as disclosed herein (e.g., as described above).

In accordance with at least one aspect of this disclosure, a method can include applying a coating to a paper base, the coating having wax and at least some ground calcium carbonate that is untreated with stearic acid. Applying the coating can include cascade coating or any other suitable process. The coating can be any suitable coating as disclosed herein (e.g., as described above).

In accordance with at least one aspect of this disclosure, a wax coating for a packaging material can include a wax and at least some calcium carbonate mixed in with the wax. The wax can be paraffin wax or any other suitable wax. The packaging material can be paper (e.g., corrugated board) or any other suitable material.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a cross-sectional view of an embodiment of a corrugated structure in accordance with this disclosure, showing;

FIG. 2 is a chart showing the relationship between calcium carbonate content/loading of a wax coating vs pickup percentage of the wax coating; and

FIG. 3 is a chart showing the relationship between calcium carbonate content/loading of a wax coating vs wet compression strength of a corrugated board coated with the wax coating.

### DETAILED DESCRIPTION

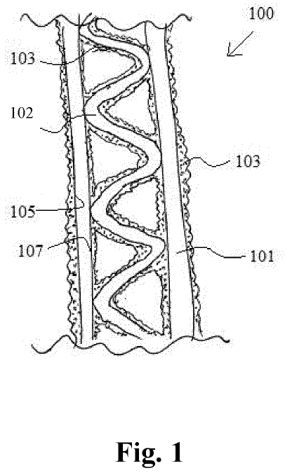

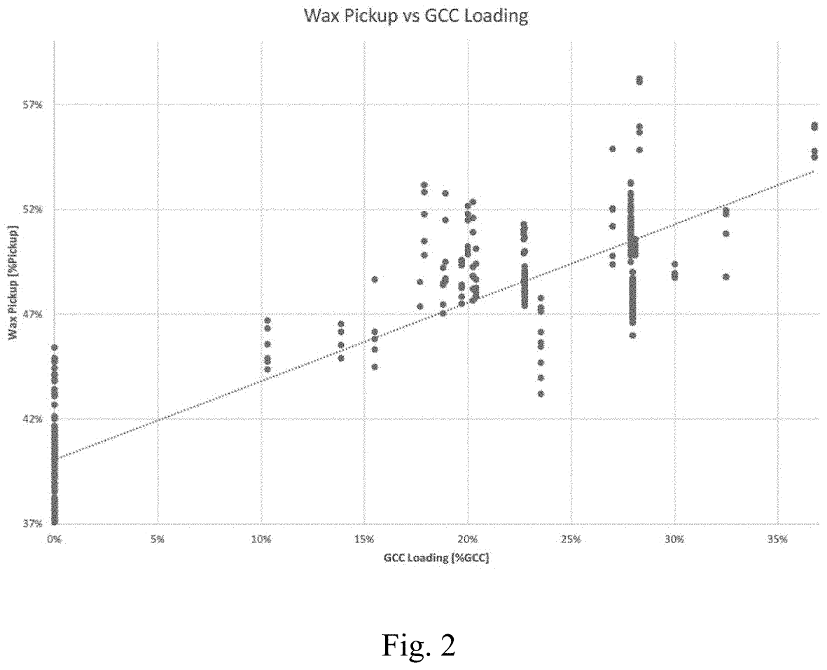

Reference will now be made to the drawings wherein like reference numerals identify similar structural features or aspects of the subject disclosure. For purposes of explanation and illustration, and not limitation, an illustrative view of an embodiment of a blank in accordance with the disclosure is shown in FIG. 1 and is designated generally by reference character 100. Other embodiments and/or aspects of this disclosure are shown in FIG. 2.

In accordance with at least one aspect of this disclosure, referring to FIG. 1, a cross section of a corrugated structure 100 used to form a packaging blank 100 can include an inner and outer paper liner board 101 and a corrugating medium 102. The structure 100 can include a coating 103 disposed on and/or within the paper structure 100. The coating 103 can include wax and at least some ground calcium carbonate. The paper base 101 can be corrugated paper board, for example (e.g., as shown). The wax can be or include paraffin wax, or any other suitable waxes or substances such as hydrogenated triglycerides including tallow-based, palm or soy-based that perform similarly to wax (e.g., for moisture protection) and can be mixed with calcium carbonate. Other mineral fillers, such as dolomite or talc, may be used instead of or in combination with calcium carbonate.

Preferably, the ground calcium carbonate is untreated with stearic acid. Untreated ground calcium carbonate hydrophobicity is 0% with a contact angle of 0 degrees and is considered a hydrophilic material. In one example, the ground calcium carbonate used had a mean particle size of approximately 2 microns or less.

The at least some calcium carbonate can be between greater than zero percent by weight and less than about 50% by weight of the coating. For example, the at least some calcium carbonate can be between about 10% by weight and about 40% by weight of the coating. Any other suitable amount of calcium carbonate for the coating 103 (e.g., to provide increased strength without compromising the function of the wax) is contemplated herein.

The coating 103 can be disposed on at least one exterior surface 105 of the liner board 101. The coating 103 can be disposed on at least one interior surface 107 of the liner board 101. In certain embodiments, the coating 103 can be disposed on all surfaces of the corrugated stricture 100, including the surfaces of the corrugating medium 102 (e.g., as shown in FIG. 1).

In accordance with at least one aspect of this disclosure, a package can be created from at least one packaging blank. The package can include any suitable packaging blanks and/or features thereof as disclosed herein (e.g., as described above). The package can be a box, tray or bin for produce, meat, fish, live plants or other moisture laden products, for example. Any other suitable package for containing any other suitable item is contemplated herein.

In accordance with at least one aspect of this disclosure, a method can include applying a coating to a paper base, the coating having wax and at least some calcium carbonate. Applying the coating can include cascade coating, spray coating or any other suitable process as appreciated by those having ordinary skill in the art. The coating can be any suitable coating as disclosed herein (e.g., as described above).

In accordance with at least one aspect of this disclosure, a wax coating for a packaging material can include a wax and at least some calcium carbonate mixed in with the wax. The wax can be paraffin wax or any other suitable wax or wax blend, for example. The packaging material can be paper (e.g., corrugated board) or any other suitable material.

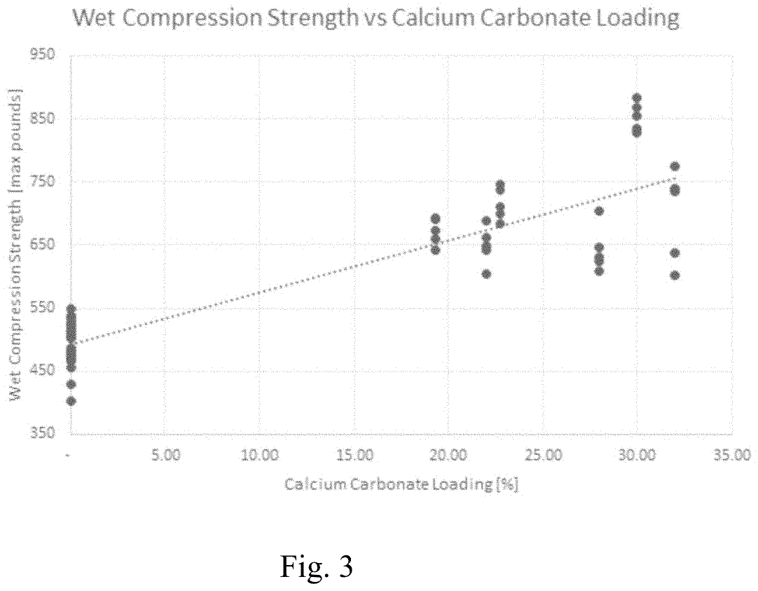

Surprisingly, it has been discovered that the addition of calcium carbonate to, e.g., paraffin wax in a cascade waxing process does not diminish the performance of the coating. To the contrary, the addition of calcium carbonate greatly improves the wet compression strength of, e.g., a corrugate box made from such a coated material. This can allow for lighter weight packaging structures (e.g., thinner blanks and/or boxes made therefrom) that deliver equivalent performance to more robust structures, for example. Also, the addition of calcium carbonate in paraffin wax lowers the wax content of the coating and therefore the cost basis of the paraffin wax, for example. This is due to calcium carbonate being significantly less costly than paraffin wax. The more calcium carbonate added, the lower the cost and the mixture. FIG. 2 shows the relationship between wax pickup into the paper as a function of the weight percent of ground calcium carbonate (i.e., the GCC loading) in the wax coating. Various basis weights of liner board were coated with paraffin wax (Parafflex® wax available from The International Group, Inc.) blended with various ratios of untreated ground calcium carbonate (available from Omya Inc.). As shown in FIG. 2, it has been discovered that the more calcium carbonate added, the more wax pickup is achieved in the cascading process. Because wax pickup is directly related to increased strength in the coated material, the addition of calcium carbonate leads to the observed improvement in container strength. FIG. 3 shows the increased wet compression strength achieved as a function of ground calcium carbonate loading in the applied coating.

Certain embodiments can be used in cascade waxed corrugate boxes, trays or bins (e.g., for produce or any other type of item), for example. Embodiments can allow use of lighter paperboard boxes and/or blanks into the coating process (e.g., wax cascading process) and provide equivalent wet compression performance with the use of calcium carbonate filled wax. Additionally or alternatively, by replacing a portion of the wax in the coating with calcium carbonate, the quantity of wax required to achieve equivalent or improved compression strength may be reduced.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

Any suitable combination(s) of any disclosed embodiments and/or any suitable portion(s) thereof are contemplated herein as appreciated by those having ordinary skill in the art.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A packaging blank, comprising:
a paper base; and
a coating disposed on and/or within the paper base, the coating comprising wax and at least some calcium carbonate, wherein the calcium carbonate is untreated with stearic acid.

2. The blank of claim 1, wherein the paper base is corrugated paper board.

3. The blank of claim 1, wherein the wax is or includes paraffin wax.

4. The blank of claim 1, wherein the calcium carbonate is a ground calcium carbonate.

5. The blank of claim 4, wherein the ground calcium carbonate has a mean particle size of not more than approximately 2 microns.

6. The blank of claim 4, wherein the ground calcium carbonate has a mean particle size of approximately 2 microns.

7. The blank of claim 1, wherein the at least some calcium carbonate loading is between greater than zero percent by weight and less than about 50% by weight of the coating.

8. The blank of claim 7, wherein the at least some calcium carbonate is between about 10% by weight and about 40% by weight of the coating.

9. The blank of claim 1, wherein the coating is disposed on at least one exterior surface of the paper base.

10. The blank of claim 1, wherein the coating is disposed on at least one interior surface of the paper base.

11. The blank of claim 1, wherein the coating is disposed on all surfaces of the paper base.

12. A package created from at least one packaging blank, the package comprising:
a paper base; and
a coating disposed on and/or within the paper base, the coating comprising wax and at least some calcium carbonate, wherein the calcium carbonate is untreated with stearic acid.

13. The package of claim 12, wherein the paper base is corrugated paper board.

14. The package of claim 12, wherein the wax is or includes paraffin wax.

15. The package of claim 12, wherein the calcium carbonate is a ground calcium carbonate.

16. The package of claim 15, wherein the ground calcium carbonate has a mean particle size of not more than approximately 2 microns.

17. The package of claim 15, wherein the ground calcium carbonate has a mean particle size of approximately 2 microns.

18. The package of claim 12, wherein the at least some calcium carbonate loading is between greater than zero percent by weight and less than about 50% by weight of the coating.

19. The package of claim 18, wherein the at least some calcium carbonate is between about 10% by weight and about 40% by weight of the coating.

20. The package of claim 12, wherein the coating is disposed on at least one exterior surface of the paper base.

21. The package of claim 12, wherein the coating is disposed on at least one interior surface of the paper base.

22. The package of claim 12, wherein the coating is disposed on all surfaces of the paper base.

23. A method, comprising:
applying a coating to a paper base, the coating having wax and at least some ground calcium carbonate that is untreated with stearic acid.

24. The method of claim 23, wherein applying the coating includes cascade coating.

25. The method of claim 23, wherein the coating includes calcium carbonate between greater than zero percent by weight and less than about 50% by weight of the coating.

26. A wax coating for a packaging material, comprising:
a wax; and
at least some hydrophilic mineral filler mixed in with the wax.

27. The wax coating of claim 26, wherein the hydrophilic mineral filler comprises ground calcium carbonate that is untreated with stearic acid
